(19) United States
(12) Patent Application Publication
(10) Pub. No.: US 2009/0188117 A1
(43) Pub. Date: Jul. 30, 2009

(54) COMB DEVICE AND HAIR-CUTTING SYSTEM

(75) Inventor: Arthur Putzer, Bad Eisenkappel (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,832

(22) PCT Filed: May 3, 2007
(86) PCT No.: PCT/IB2007/051646

§ 371 Date: Nov. 6, 2008

(30) Foreign Application Priority Data
May 11, 2006 (EP) 06113799.8

(51) Int. Cl. B26B 19/00

(52) U.S. Cl. 30/201; 30/233.5

(57) ABSTRACT

To avoid miscuts while providing a comfortable usability a comb device (3) for a hair-cutting system (1) is proposed, the comb device (3) comprising a comb unit (4) with teeth (71) and connecting means (8) for connecting the comb device (3) to a hair-cutting apparatus (2), wherein the comb unit (4) comprises a first part (5) being in a fixed position with respect to the connecting means (8) and having teeth (71) and a second part (6) being movable with respect to the connecting means (8), as well a hair-cutting system comprising a hair-cutting apparatus and such a comb device (3) and being divided in two or more movable subparts (61, 62) that are arranged to move independently from each other.

The present invention relates to a comb device for a hair-cutting system.

The present invention further relates to a hair-cutting system with a comb device according to the present invention.

Usual hair-cutting systems comprise a hair-cutting apparatus and a comb device. The hair-cutting apparatus usually has a cutting unit with e.g. two blades moved relatively to one another with help of a motor. The cutting device is normally mounted on a casing housing the motor or batteries as power supply for the hair-cutting device, wherein the casing also serves as handle for hand-held hair-cutting systems.

To define a certain cut length, a comb device with comb teeth is mounted on the casing and covering the cutting unit. The actual hair-cutting length is defined by the length of the comb teeth. The hair length is equivalent to the distance of the blades to the skin whereon the comb device mounted on the hair-cutting apparatus is applied for cutting hair. To enlarge the range of usability of the hair-cutting system, either different comb units having fins with various lengths and/or comb units adjustable with respect to the cutting unit are provided to allow for haircuts of different lengths.

In order to guarantee a correct hair-cutting process, the hair-cutting apparatus with the comb device should always be held in such a relative position with respect to the skin area with hair to be cut, that, as the comb teeth of the comb device are moved over the skin area, an optimum contact with the skin area is achieved for the comb teeth. Especially for non-professional users being less experienced and having less dexterity this can be quite difficult, especially if one is cutting one's own hair in areas difficult to reach.

EP 1 047 531 B1 addressed this problem by providing a hair-cutting system including a hair-cutting apparatus for cutting hairs, said apparatus being held in a hand during operation and having a toothed cutting device, and including a comb device mounted on the hair-cutting apparatus in the area of the its toothed cutting device and having juxtaposed comb teeth. The comb teeth have a distal tooth end and a proximal tooth end and a contact zone extending between the two tooth ends. At least the tooth ends are connected to holding means of the hair-cutting apparatus with the aid of connecting means. The connecting means are constructed to enable the angular position of at least the comb teeth of the comb device with respect to the hair-cutting apparatus to be changed continually during operation. The connecting means are further constructed and arranged in such a manner that, when during operation of the hair-cutting system at least some of the comb teeth are moved over a skin area and the relative position of the hair-cutting system to this skin area is changed, a continual contact with this skin area is automatically guaranteed for at least those parts of the contact zones of the comb teeth which adjoin the distal tooth ends by a continual change of the angular position of the comb teeth. This is mainly achieved by including pivoting means in the connecting means. With the aid of the pivoting means the comb teeth of the comb device can be tilted with respect to the hair-cutting apparatus.

At least in the area of their distal ends, the comb teeth always occupy a position relative to a skin area, which is advantageous for a proper raising of hairs, so that always a proper cutting performance is achieved.

It is an object of the present invention to further develop the comb device and the hair-cutting system of the state of the art.

In a first aspect of the present invention, this object is achieved by a comb device for a hair-cutting system, the comb device comprising a comb unit with teeth and comprising connecting means for connecting the comb device to a hair-cutting apparatus, wherein the comb unit comprises a first part being in a fixed position with respect to the connecting means and having teeth, and a second part being movable with respect to the connecting means and being divided in two or more movable subparts that are arranged to move independently from each other.

It has been found that a comb device with a comb unit having a fixed, toothed part and a movable part allows for a comfortable usability even for inexperienced users. The teethed part has the function of combing and raising the hair as well of determining the cut length, and by being in a fixed position with respect to the connecting means as well as with respect to some cutting device of the hair-cutting apparatus, it efficiently avoids miscuts, while the movable part is apt to adapt to the contour of skin area during operation, making the movement of the person operating the hair-cutting system smoother, even if the person is cutting hair on his or her own head or body.

Each movable subpart moves independently from the other movable subpart(s), thus particularly improving the adaptation of the comb device's comb unit to the contour of the skin during operation and the smoothness of the movement. The movable subparts ensure a permanent and close contact of the comb unit with the skin, while the fixed toothed part ensures the right hair cut length. Especially too short hair cuts are avoided. This enhances the comfort of usage of a hair-cutting system with a comb device according to the invention for both professional and non-professional users. In particular with respect to small comb devices, the movable second part may be designed to allow for a good sight on the cutting process by e.g. providing only a small number of additional comb teeth, i.e. less than there are at the fixed first part, or movable subparts being not too large.

Thus, the comb device according to the present invention improves the usability of hair-cutting systems using comb devices. As the comb device's connecting means are the same as for conventional comb devices, the comb device may be attached to any hair-cutting apparatus configured to accommodate a comb device. Comb devices according to the present invention may be designed with different teeth lengths, or may have the functionality to be adapted to different distances between the cutting device and the end of the teeth touching the skin to allow for different cut length with one comb device.

As not the whole comb unit is movable, the construction of the comb unit may be designed to need less space and allow for smaller comb devices as well as for smaller hair-cutting systems, e.g. for traveling.

Advantageously, the comb device has pivoting means connecting the movable second part with the connecting means. A preferred movement is a pivoting movement of the movable second part to adapt especially smoothly to the contour of the skin where hair is to be cut.

The movable second part, be it divided in movable subparts or not, should have at least one point of contact with the skin area the comb device attached to a hair-cutting apparatus is applied to, to fulfill its guiding function. Preferably, there are one or more contact zones, the contact zone(s) following the surface contour of the skin during operation thanks to the movability of the second art of the comb unit. In some preferred embodiments, the contact zone(s) are designed as comb teeth. Advantageously, these comb teeth of the movable second part are arranged more or less in continuation of the comb teeth of the fixed first part of the comb unit and support their combing function.

Advantageously, the pivoting means comprise a resilient element to ensure that the movable second part reacts quickly to any change of the surface contour while efficiently fulfilling its guiding function.

In preferred embodiments of the present invention, the pivoting means is designed to allow for movement in more than one direction to take into account that in most cases hair is not only cut on large areas that are only slightly curved in one direction, but also on areas with strong curvatures in more than one direction, such as e.g. the chin.

In a further aspect of the present invention, this object is achieved by a hair-cutting system including a hair-cutting apparatus having a cutting device with at least one blade, and including a comb device according the present invention mounted on the hair cutting apparatus in the area of the cutting device.

Such a hair-cutting system allows for a comfortable usability even for inexperienced users. The fixed first part with teeth of the comb device's comb unit has the function of combing and raising the hair as well of determining the cut length, and by being in a fixed position with respect to the cutting device of the hair-cutting apparatus, it efficiently avoids miscuts. Simultaneously, the movable part is apt to adapt to the contour of skin area during operation, making the movement of the person operating the hair-cutting system smoother, even if the person is cutting hair on his or her own head or body. The construction of the comb unit may be designed to need less space and allow for smaller comb devices. By downscaling also the hair-cutting apparatus, smaller hair-cutting systems, e.g. for traveling, can be provided.

The movable second part of the comb device is pivoting around an axis that is basically parallel to the blade of the cutting device to follow the contour of the skin area particularly in the moving direction of the hair-cutting apparatus. Advantageously, the movable second part of the comb device is additionally pivoting around an axis that is basically perpendicular to the blade of the cutting device to adjust for eventual height variations perpendicular to the moving direction of the hair-cutting apparatus.

In cutting direction, the fixed first part with teeth of the comb unit is arranged in front of the movable second part of the comb unit to ensure a most efficient combing and upraising function of the fixed first part of the comb unit to provide the desired haircut length with a minimum of deviations.

A detailed description of the invention is provided below. Said description is provided by way of a non-limiting example to be read with reference to the attached drawings in which:

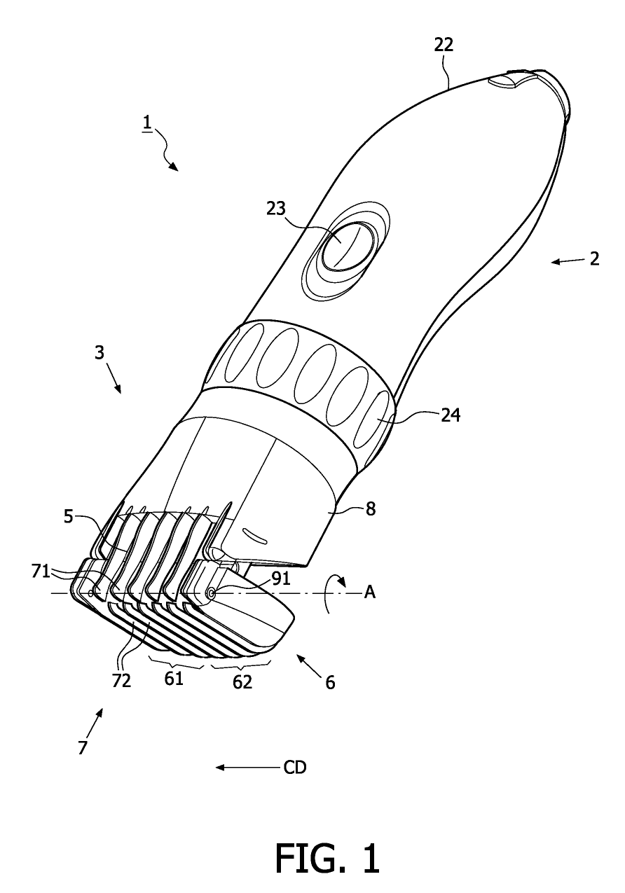

FIG. 1 shows a preferred embodiment of the hair-cutting system according to the present invention;

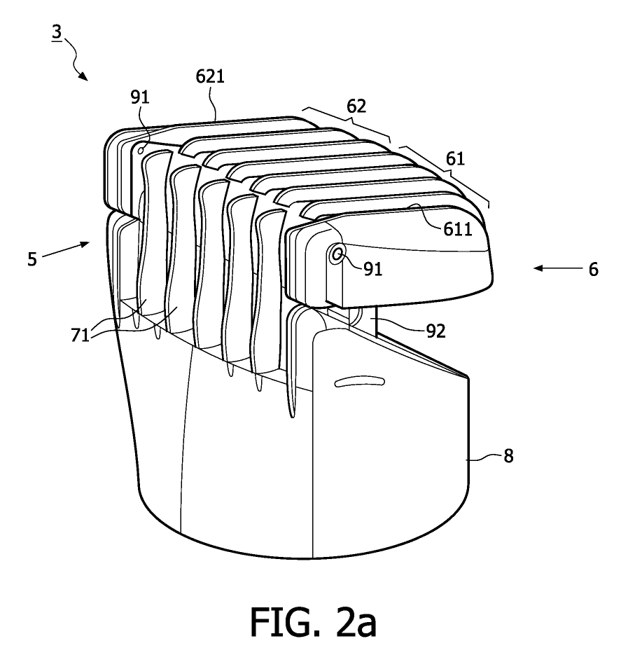

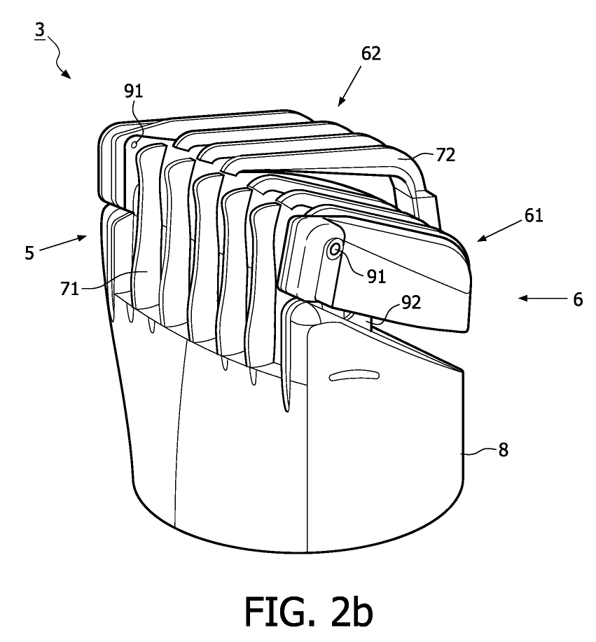

FIGS. 2a,b illustrate a first group of embodiments of the comb device according to the present invention in different positions of the movable second part;

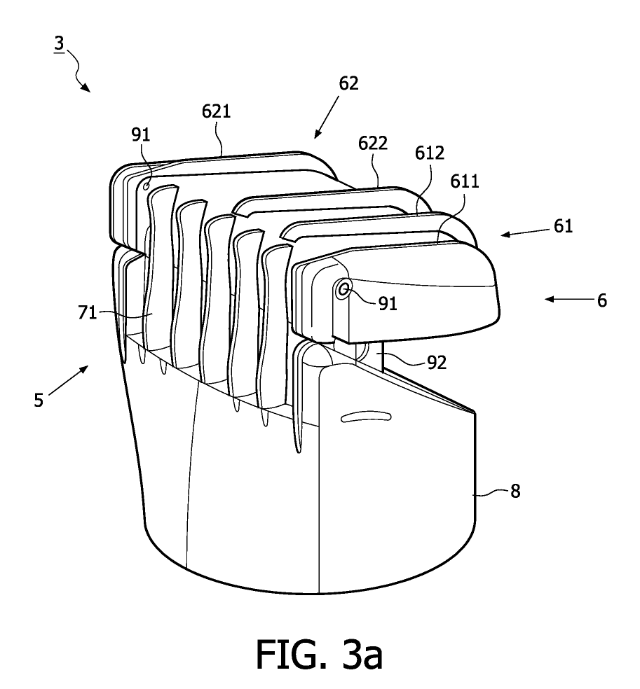

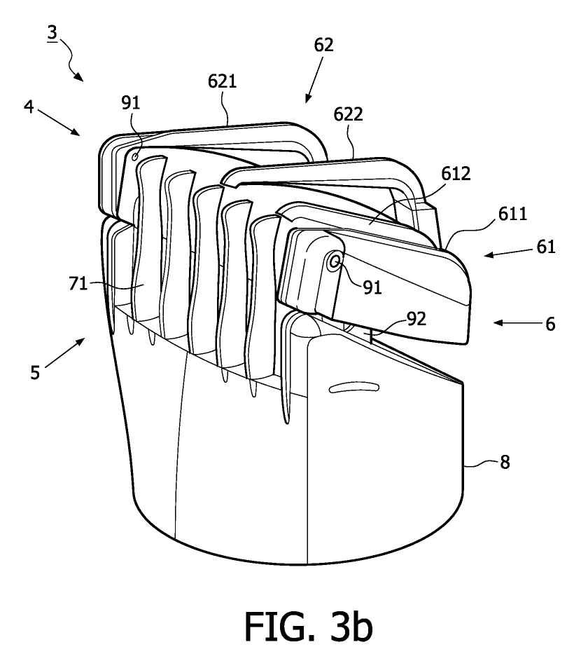

FIGS. 3a,b illustrate a second group of embodiments of the comb device according to the present invention in different positions of the movable second part;

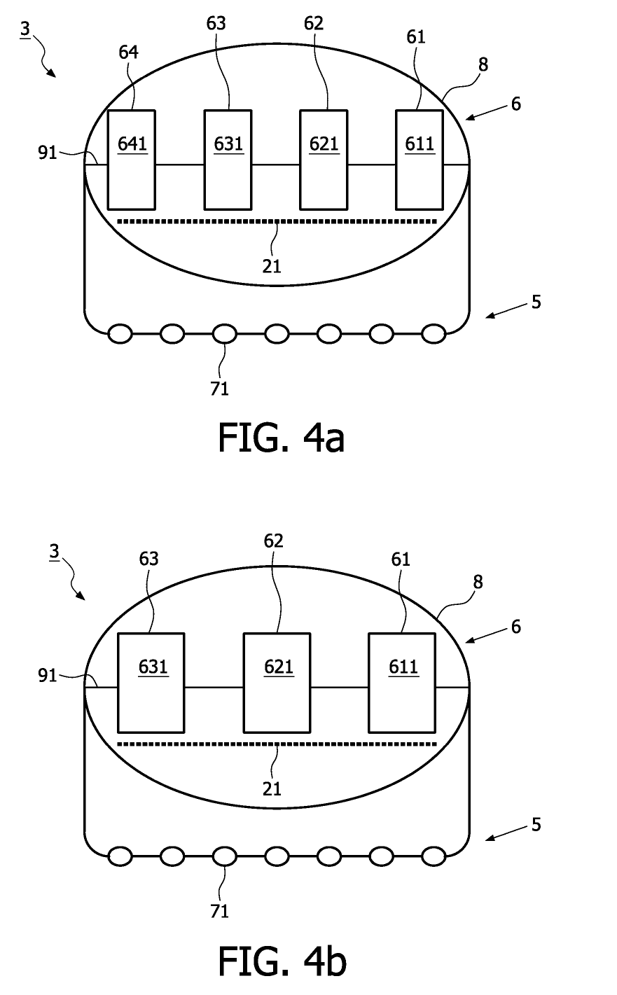

FIGS. 4a,b illustrate a third group of embodiments of the comb device according to the present invention; and

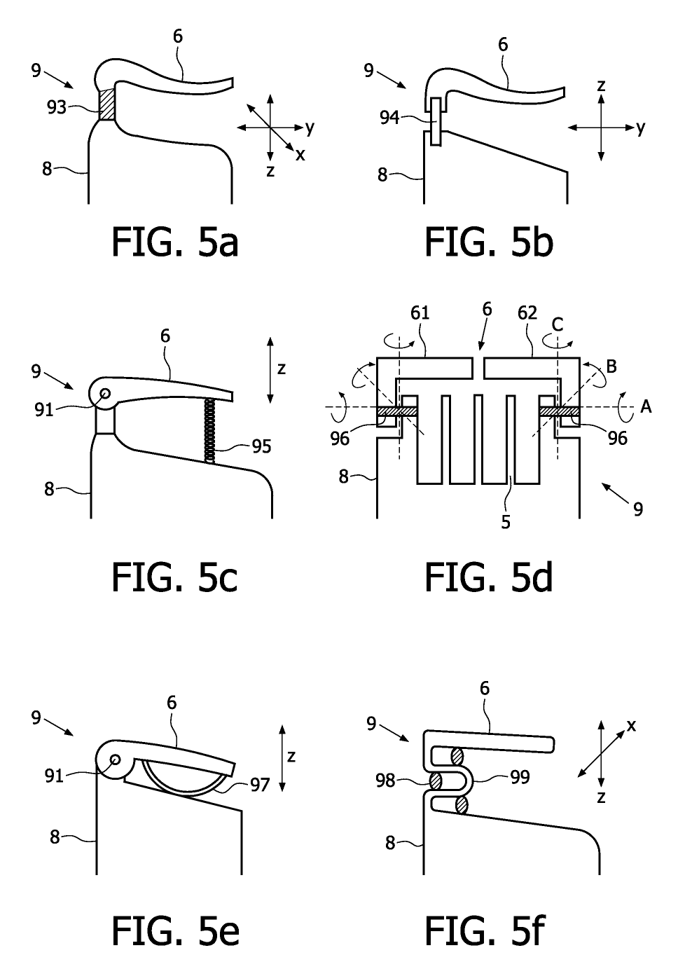

FIGS. 5a-f illustrate various embodiments of the pivoting means.

FIG. 1 shows a hair-cutting system 1 according to the present invention comprising a hair-cutting apparatus 2 and a comb device 3. The hair-cutting apparatus 2 has a casing 22 with the function of a handle and housing a battery to power a motor driving a cutting unit with reciprocating blades as known in the state of the art. It will be noted that other means of powering the motor are possible such as using an external power supply or a rechargeable battery. The hair-cutting apparatus may be switched on and off by the switch 23 on the casing 22.

The motor drives the reciprocating blade of the cutting unit, whereas the other blade is stationary. Both blades are elongated and arranged in parallel. They have little teeth that do the actual cutting of hair stuck between them during the reciprocating action. In the present FIG. 1, the cutting unit is hidden by the comb device 3. The cutting length, i.e. the distance between the cutting blades and the distal end of the comb devices teeth 7, approximately at the level of the pivoting axis A in FIG. 1, is adjusted mechanically with help of the adjusting ring 24. By rotating the adjusting ring 24, the comb device 3 is moved along the longitudinal axis of the hair-cutting apparatus 2.

The comb device comprises a comb unit 4 and connecting means 8 connecting the comb unit 4 to the hair-cutting apparatus 2. In the present example the connecting means 8 is basically cylindrical and is put over the cutting unit of the hair-cutting apparatus 2. It will be noted that any other kind of connecting means known to the person skilled in the art may be utilized as well.

The comb unit 4 of the comb device 3 has a first part 5 with comb teeth 71 that is in a fixed position with respect to the connecting means 8, and a second part 6 that can change its position with respect to the connecting means 8 by means of a pivoting movement around the pivoting axis A. To achieve this pivoting movement, the movable second part 6 of the comb unit 4 is connected to the connecting means 8 via a pivoting spindle 91. The movable second part 6 of the comb unit 4 is divided in two movable subparts 61, 62. Each movable subpart 61, 62 moves independently from the other movable subpart 62, 61, thus further improving the adaptation of the comb device's comb unit to the contour of the skin during operation and the smoothness of the movement.

It has been found that a comb device 3 with a comb unit 4 having a fixed, toothed part 5 and a movable part 6 with two or more movable subparts 61, 62 allows for a comfortable usability even for inexperienced users. The teeth 71 of the fixed first part 5 comb and raise the hair as well as determine the cut length with respect to the cutting blades. Thus, it efficiently avoids miscuts, while the movable second part 6 is apt to adapt to the contour of skin area during operation, making the movement of the person operating the hair-cutting system smoother, e.g. when trimming beards or moustaches, shaving arm pits or pubic areas or simply cutting hair on the head by oneself. It will be noted that the hair-cutting system 1 according to the present invention may as well be used to trim animals, to shave patients in preparation of a chirurgical intervention, or may be used by professional hairdressers and barbers.

As the fixed first part 5 with teeth 71 is arranged in cutting direction CD in front of the movable second part 6, the hair-raising function is optimized as is the combing function. The movable second part 6 of the comb unit 4 illustrated in FIG. 1 has teeth 72 arranged in continuation of the teeth 71 of the fixed first part 5 of the comb unit 4 to assist the teeth 71 in their combing function.

FIGS. 2 a, b show more in detail the comb device 3 of the hair-cutting system 1 shown in FIG. 1. In FIG. 2a, the largeness of the movable subpart 61 is equivalent to four teeth 72, and the largeness of the movable subpart 62 is equivalent to three teeth 71, and vice-versa in FIG. 2b. Each movable subpart 61, 62 is attached via its own pivoting spindle 91 to a respective attaching leg 92 (visible only for mobile art 61) connecting to the connecting means 8. In FIG. 2a, both movable subparts 61, 62 are in the same position with respect to the connecting means 8. In FIG. 2b, the movable subpart 61 is nearer to the connecting means 8 than the movable subpart 62. This is e.g. equivalent to a part of the body with hair to be cut with a bump on the side of the movable subpart 61 that is higher than the area on the side of the movable subpart 62.

FIGS. 3 a, b show further embodiments of the comb device 3. Differently from the former embodiments, the movable subparts 61, 62 of the movable second part 6 of the comb unit 4 have much less teeth 72 than the fixed first part 5. The main function of the teeth 72 is to define contact points or contact zones 611, 612, 621, 622, where the movable second part 6 of the comb unit 4 comes in contact with the body surface during operation. Depending on the contour of this surface, each movable subpart 61, 62 pivots independently. Again, in FIG. 3a, both movable subparts 61, 62 are in the same position with respect to the connecting means 8, and in FIG. 3b, the movable subpart 61 is nearer to the connecting means 8 than the movable subpart 62.

FIGS. 4 a, b show schematically further embodiments of the comb device 3. In these examples, the movable second part 6 has no teeth at all, but only three (in FIG. 4a) or four (in FIG. 4b) movable subparts 61, 62, 63, 64, each defining a contact point or contact zone 611, 621, 631, 641. It will be noted, that only one or two or five or more movable subparts could be provided. In the same way, embodiments where the movable second part of the comb unit has teeth, as in FIGS. 1 to 3, more than one or two movable subparts could be provided. It will further be noted that FIGS. 4 a, b illustrate schematically that the comb device is put over and covering the blades 21 of the hair-cutting apparatus' cutting unit.

FIGS. 5 a-f show schematically further embodiments of pivoting means 9. In FIG. 5a, an elastic element 93 has been chosen to attach the movable second part 6 to the connecting means 8, allowing for three degrees of freedom of the pivoting movement, i.e. a movement in all three direction x, y, z, to optimally adapt the position of the movable second part 6 to the skin surface contour.

In FIG. 5b, a metal leaf spring 94 replaces the elastic element 93 of the pivoting means 9 of FIG. 5a, allowing two degrees of freedom, in direction z and—but less than in direction z—in direction y, direction z being the most important direction for the purpose of the present invention.

The movement in z-direction is as well allowed in the embodiments of FIGS. 5c and e, where a pivoting spindle 91 is combined with a spiral spring 95 in FIG. 5c and with a leaf spring 97 in FIG. 5e, both spring 95, 97 ensuring that the movable second part 6 reacts quickly to any change of the surface contour while efficiently fulfilling its guiding function by continuously staying in contact with the respective skin area.

Similarly to the embodiment of FIG. 5a, the embodiment of FIG. 5d allows for three degrees of freedom of the movable second part 6 for each movable subpart 61, 62, i.e. around the axes A, B, C. Instead of using an elastic element, a torsion bar spring 96 is used.

The pivoting means 9 shown in FIG. 5f comprises a curved connecting part 99 with elastic elements 98 to resiliently stiffen the connecting part 99. This kind of pivoting means allows basically two degrees of freedom, in z-direction and x-direction.

It will be noted that the possible range of movements of all pivoting means 9 with resilient and/or elastic components depend on the specific characteristics of the respective components.

Although having described several preferred embodiments of the invention, those skilled in the art would appreciate that various changes, alterations, and substitutions can be made without departing from the spirit and concepts of the present invention. The invention is, therefore, claimed in any of its forms or modifications with the proper scope of the appended claims. For example various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 hair-cutting system
2 hair-cutting apparatus
21 cutting blades
22 casing
23 switch
24 adjusting ring
3 comb device
4 comb unit
5 fixed first part
6 movable second part
61 first movable subpart
62 second movable subpart
63 third movable subpart
64 fourth movable subpart
611 first contact zone of first movable subpart
612 second contact zone of first movable subpart
621 first contact zone of second movable subpart
622 second contact zone of second movable subpart
631 contact zone of third movable subpart
641 contact zone of fourth movable subpart
7 comb teeth
   71 comb teeth of fixed first part
72 comb teeth of movable second part
8 connecting means
9 pivoting means
91 pivoting spindle
92 attaching leg
93 elastic element
94 leaf spring
95 spiral spring
96 torsion bar spring
97 leaf spring
98 elastic element
99 curved connecting part
x, y, z axes of movement of movable second part
A, B, C pivoting axis
CD cutting direction

1. A comb device (3) for a hair-cutting system (1), the comb device (3) comprising a comb unit (4) with teeth (7, 71, 72) and connecting means (8) for connecting the comb device (3) to a hair-cutting apparatus (2), characterized in that the comb unit (4) comprises a first part (5) being in a fixed position with respect to the connecting means (8) and having teeth (71) and a second part (6) being movable with respect to the connecting means (8) and being divided in two or more movable subparts (61, 62, 63, 64) that are arranged to move independently from each other.

2. The comb device according to claim 1, characterized in that it has pivoting means (9) connecting the movable second part (6) with the connecting means (8).

3. The comb device according to claim 1, characterized in that the second movable part (6) has comb teeth (72) as well.

4. The comb device according to claim 2, characterized in that the pivoting means (9) comprise a resilient element (93, 94, 95, 96, 97, 98, 99).

5. The comb device according to claim 2, characterized in that the pivoting means (9) is designed to allow for movement in more than one direction.

6. A hair-cutting system (1) including a hair-cutting apparatus (2) having a cutting device with at least one blade (21), and including a comb device (3) according to claim 1 mounted on the hair cutting apparatus (2) in the area of the cutting device (21).

7. The hair-cutting system according to claim 6, characterized in that the movable second part (6) of the comb device (3) is pivoting around an axis (A) that is basically parallel to the blade (21) of the cutting device.

8. The hair-cutting system according to claim 7, characterized in that the movable second part (6) of the comb device (3) is pivoting around an axis (B, C) that is basically perpendicular to the blade (21) of the cutting device.

9. The hair-cutting system according to claim 6, characterized in that in cutting direction (CD), the fixed first part (5) with teeth (71) of the comb unit (4) is arranged in front of the movable second part (6) of the comb unit (4).
